(19) United States
(12) Patent Application Publication
(10) Pub. No.: US 2007/0220035 A1
(43) Pub. Date: Sep. 20, 2007

(54) Generating user interface using metadata

(76) Inventor: Filip Misovski, Frankfurt (DE)

Correspondence Address: FISH & RICHARDSON, P.C., PO BOX 1022, MINNEAPOLIS, MN, 55440-1022, US

(21) Appl. No.: 11/377,987

(22) Filed: Mar. 17, 2006

(51) Int. Cl. G06F 7/00

(52) U.S. Cl. 707/102

(57) ABSTRACT

A method of creating a user interface includes receiving a request to create a UI for an application that is to use a service. First metadata is retrieved from a UI taxonomy that is an abstraction of a class of UIs, the first metadata providing that the created UI is a member of the class. Second metadata that defines the service is retrieved. The method comprises creating the UI by merging the first and second metadata. A computer system includes executable instructions that constitute a service, and a UI taxonomy that is an abstraction of a class of UIs. The system includes a UI generation module configured to retrieve first metadata from the UI taxonomy and second metadata that defines the service. The UI generation module generates a UI for the application by merging the first and second metadata.

### TECHNICAL FIELD

The description relates to generating a user interface by merging metadata.

### BACKGROUND

User interfaces are used in computer systems to manage the interaction between the user and the system. The user interface (UI) may inform the user of system status, visually represent data and other contents to the user, and aid the user in making an input to accomplish a desired result, to name a few examples. Such a UI may be company specific, so that a software product from one vendor has a UI that is noticeably different from that of another vendor. Thus, while some generic functionalities or screen features may be more or less identical between the two systems, they may not appear so to the user because of the differences in the respective UIs.

For some software products, the customer can modify or replace a graphical user interface (GUI) to make it fit better with the implementation. For example, the customer may wish to alter the “look and feel” of the GUI according to its company profile. For example, Adobe offers functionality to convert the GUI of Microsoft PowerPoint slides to an Adobe portable document format (PDF). However, this approach may be associated with some problems when considering the converted PDF in presentation mode. For example, texts may not show in the right size and spacing, and other GUI features may not work as intended. It may be necessary for a developer to analyze and modify the resulting GUI to correct this situation, which can cause additional costs and delay. The above is also an impediment against taking a similar approach in the area of enterprise resource planning (ERP) applications, where there number of participating vendors is very large.

Also, many software companies today regulate the creation of GUIs for their products, for example through guidelines or other rules or that apply to the GUI. The guidelines may stem from a desire to make the GUI user-friendly, from a technical restriction in the implemented system, or from legislation that requires the GUI to be accessible to the visually impaired, to name a few examples. When altering or implementing such a GUI, it is therefore important that the guidelines or rules be taken into account such that they are not inadvertently violated.

### SUMMARY

The invention relates to using metadata in creating a UI.

In a first general aspect, a method of creating a user interface includes receiving a request to create a user interface (UI) for an application that is to use a service. First metadata is retrieved from a UI taxonomy that is an abstraction of a class of UIs, the first metadata providing that the created UI is a member of the class. Second metadata that defines the service is retrieved. The method comprises creating the UI by merging the first and second metadata.

Implementations may include some or all of the following features. The service may include a web service and a UI service. The UI service may define a look-and-feel aspect of the web service. The UI taxonomy may be configured such that the class of UIs is consistent with a UI layout and a UI principle included in the UI taxonomy. At least one UI pattern and a UI topology may be included in the UI layout. The UI taxonomy may be configured such that the class of UIs is consistent also with a UI environment included in the UI taxonomy. When the service does not expose the second metadata, the method may further include creating the second metadata using the service, wherein the second metadata can be retrieved upon creation. The UI may be created to make the application a composite application for running on a first platform, wherein the UI taxonomy maps to UI objects for the first platform. The method may further include generating, in response to receiving a user input, another UI for use in running the application on a second platform. The other UI may be generated by retrieving other metadata from another UI taxonomy that maps to UI objects for the second platform, and merging that other metadata with the second metadata that defines the service.

In a second general aspect, a computer system includes executable instructions that constitute a service configured for use by an application in the computer system. The system includes a UI taxonomy that is an abstraction of a class of UIs. The system includes a UI generation module configured to retrieve first metadata from the UI taxonomy and second metadata that defines the service. The UI generation module generates a UI for the application by merging the first and second metadata.

Implementations may include some or all of the following features. The system may further include (1) an enterprise services UI layer, a UI platform layer and a virtualization layer, and the UI generation module may retrieve the first and second metadata from the UI platform layer. The service may include a web service and a UI service. The UI service may define a look-and-feel aspect of the web service. The web service may be provided from a backend layer, and the computer system may further include an intermediate platform that implements the UI service for use by the application in a composite applications layer. Several web services may be provided from the backend layer, and the intermediate platform may include an integration platform that implements the UI service for the several web services. The system may further include a UI services creation component that, when the service does not expose the second metadata, creates the second metadata using the service, wherein the second metadata can be retrieved upon creation. The UI taxonomy may be configured such that the class of UIs is consistent with a UI layout and a UI principle included in the UI taxonomy. The UI taxonomy may be further configured such that the class of UIs is consistent also with a UI environment included in the UI taxonomy.

Advantages of the systems and techniques described herein may include any or all of the following: Providing a convenient generation of a UI based on available metadata; providing flexibility in creating composite applications; making possible a consolidation of application infrastructures to a single platform; and providing that essentially any pre-existing UI can be run from a service-based application platform.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 shows a block diagram of a system that generates a UI using metadata from a taxonomy and metadata that defines a service;

FIG. 2 shows an exemplary architecture that includes a web service and a UI service;

FIGS. 3A-C show an example of generating a UI using metadata;

FIG. 4 is an example of layers that may be included in an implementation;

FIG. 5 is another example of layers that may be included in an implementation;

FIG. 6 shows an example of a UI engine and layers of an implementation;

FIG. 7 shows an example of an engine catalogue containing a UI taxonomy;

FIG. 8 shows a design time example of interaction between a repository of metadata and an enterprise services infrastructure;

FIG. 9 shows a runtime example of interaction between a repository of metadata and an enterprise services infrastructure;

FIG. 10 is a block diagram of a general computer system.

Like reference numerals in the various drawings indicate like elements.

### DETAILED DESCRIPTION

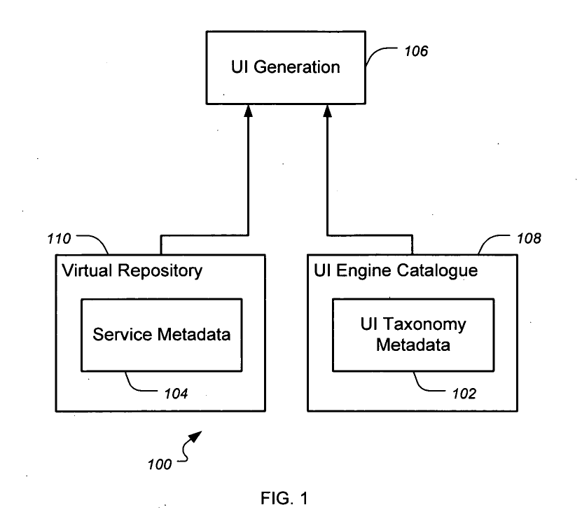

FIG. 1 shows a block diagram of a system 100 that can generate a UI using metadata. The system 100 includes metadata 102 that represents a UI taxonomy, and metadata 104 defining a service that is available in the system. The system includes a UI generation module 106 that retrieves the metadata 102 and the metadata 104. The UI generation module then creates the UI by merging the metadata 102 and the metadata 104.

The UI taxonomy represented by the metadata 102 is an abstraction of a class of UIs. The UI taxonomy may be created as a hierarchical organization of class-defining metadata, for example the UI layout that is to be used and the UI environment in which the UI is to be used. The metadata 102 provides that the UI to be created will be a member of the UI class associated with the UI taxonomy. The metadata 102 may be organized in a structure called a UI engine catalogue 108, which contains metadata and other information for use by a UI engine. For example, the UI generation module 106 can be included in a UI engine that includes the catalogue 108.

The service that the metadata 104 defines is one that has been predefined in the system to be available for use in implementations. For example, the service may be defined in the system backend and exposed from there to one or more applications. Many types of services may be used, for example in an enterprise services environment. The services may include an email message function, or one or more operations for generating an employee leave request or a new sales order document, to name just a few examples. The metadata 104 may be accessible using a component called a virtual repository 110. The virtual repository 110 provides metadata that defines particular services in terms of their look and feel. In other words, the metadata defining the available service can be retrieved to learn how one should implement and use the service.

An additional advantage of creating and storing such metadata may be obtained if there is a widespread agreement among software vendors as to what the look and feel aspects should be. For example, the vendors may agree on a standard, or otherwise adopt an essentially common practice, as to how services are to be implemented in a computer backend and how they are made available for use. In such a situation, the metadata for any given service can be used in flexibly generating a UI that implements that service. As a particular example, the UI generation module 106 can retrieve the metadata for the selected service, which here is assumed to have format and contents that comply with a standard, and also retrieve the UI taxonomy metadata which defines the parameters applicable to the UI to be created. By merging these respective metadata, the UI generation module can generate a UI that is a member of the UI class associated with the UI taxonomy and that operates with the service defined by the service metadata.

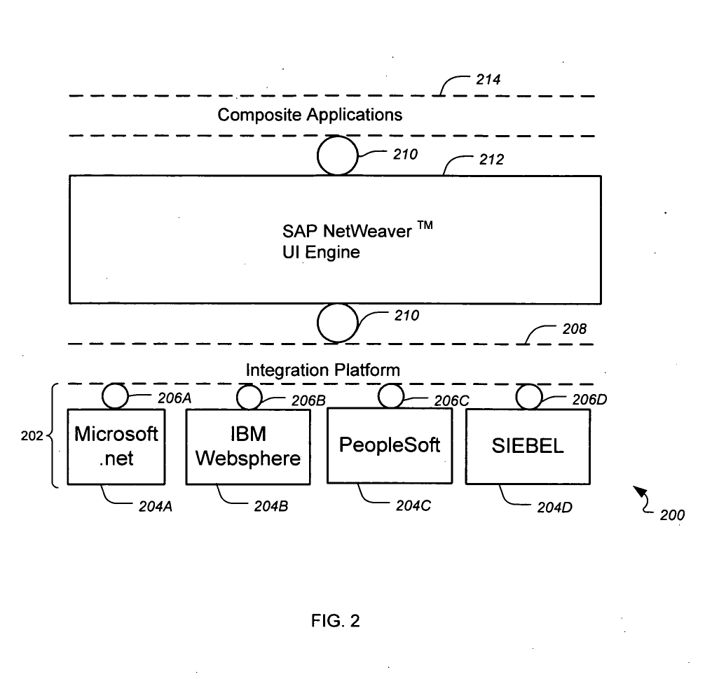

FIG. 2 shows an architecture 200 in which a UI created by retrieving and merging metadata is used to make one or more services available to a user. The architecture 200 includes a backend portion 202 that can include components from one or more vendors. Here, for example, the backend portion includes a Microsoft.net component 204A, an IBM WebSphere component 204B, a PeopleSoft component 204C and a Siebel component 204D. Each of these components is configured to serve a specific purpose in the system, for example an ERP function.

Particularly, each of the components 204 may be configured to expose certain business logic as a web service 206. The web service depends on the backend logic it is associated with, and different web services may therefore be exposed by the different backend components. Accordingly, the Microsoft net component 204A may be configured to provide a first web service 206A, the IBM WebSphere component 204B may provide a second web service 206B, the PeopleSoft component 204C may provide a third web service 206CA, and the Siebel component 204D may provide a fourth web service 206D. Any or all of the backend components may provide more than one web service.

The web services provided by different vendors may adhere to a common format such that they can be universally and flexibly used. For example, this can be accomplished if some or all large enterprise software vendors create and adopt a standard that defines the look-and-feel of a web service. That is, the standard should define how web services work and how others should be able to use them. Such a definition establishes the metadata that should be used when interacting with a web service. For any given web service the metadata can be stored (e.g., using the virtual repository 110), and by retrieving that metadata one can gain the information needed to flexibly and conveniently define a UI for the underlying backend component.

The architecture 200 includes an integration platform 208 that provides an integrated view on some or all functionality provided by the backend components 204. For example, the integration platform groups the web services 206 from the underlying components. Particularly, the integration platform provides a UI service 210 that is associated with a specific web service. The UI service contains metadata that is necessary for interacting with that web service. The UI service may also contain optional U metadata for the web service. As such, the UI service defines a look and feel of that particular web service.

The architecture 200 includes a platform 212 that makes one or more of the UI services 210 available for use in composite applications 214. For example, the platform 212 may include the NetWeaver platform that is available from SAP AG, enhanced with a UI engine that can manage the relevant metadata. The composite applications 214, in turn, may include pre-existing ERP functions operable through a UI of the customer's choice, as will be described below.

The virtual repository 110 may be the place where the metadata for the one or more available web services is held. The UI taxonomy metadata 102 may be accessible in the UI engine catalogue 108 and can include information about the layout to be used in the UI, the principles that should be applied, the environment in which the UI is implemented, and the style of the UI, to name a few examples. These types of metadata can be used in creating a UI for one or more of the composite applications 214; that is, an application where backend functionality is provided using a pre-existing UI that may not originally have been associated with the backend component. Particularly, the new UI can be created by merging the UI service metadata and the UI taxonomy metadata. The procedure of accessing the bodies of metadata and merging them will sometimes be referred to as “virtualization”. The virtual repository may be based on an open architecture to provide communication with any integrated development environment (IDE) or development tool for modeling and creating composite applications.

For example, assume that a customer has a customer relationship management (CRM) system from Siebel, but likes to run the UI of the sales order for its mobile workforce on the SAP NetWeaver platform. The customer's incentive in doing so may be to lower the total cost of ownership on the UI runtimes (platforms) that the customer supports.

Siebel's sales order is accessible as a web service in this example. The corresponding UI service would represent the UI metadata of that particular web service. If the UI metadata for the web service is not available, then the UI service can be modeled using a service builder to be described below. The virtual repository contains the metadata of the UI services (or can point to the appropriate platform where the UI service builder can retrieve this metadata).

The UI services metadata from the virtual repository will be considered in creating the composite application for the sales order. This is done by the UI generation module 106, which may be implemented in an IDE such as the NetWeaver Development Studio. Because the customer here wants the sales order to be available for its mobile workforce, there will be selected a UI taxonomy for mobile solutions, namely one that corresponds to the SAP Mobile Workforce solution. As such, the Siebel CRM application in this example becomes a backend system, and the customer only needs the NetWeaver platform for UI virtualization of its mobile scenario of a sales order.

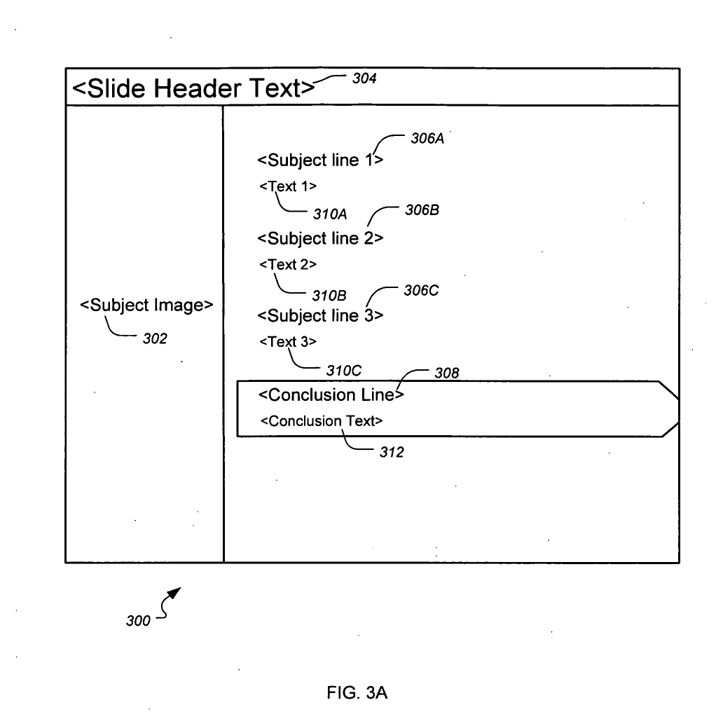

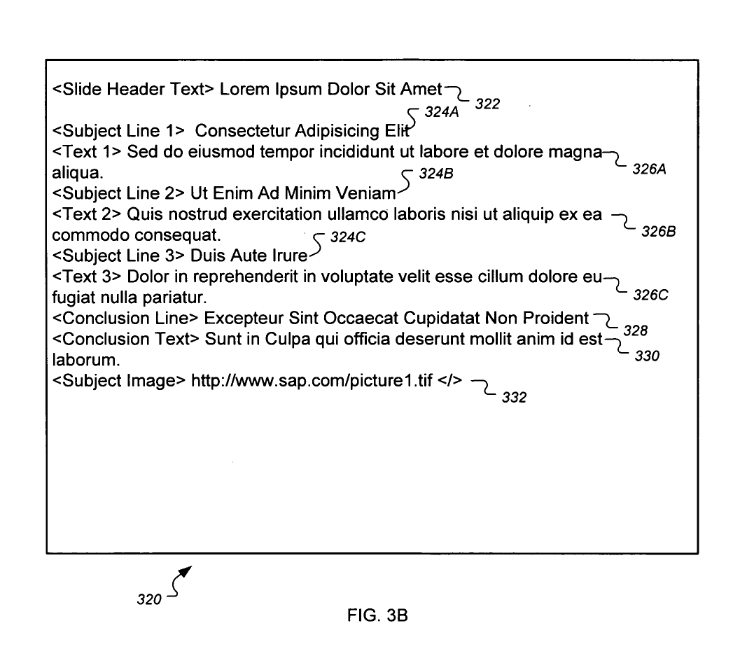

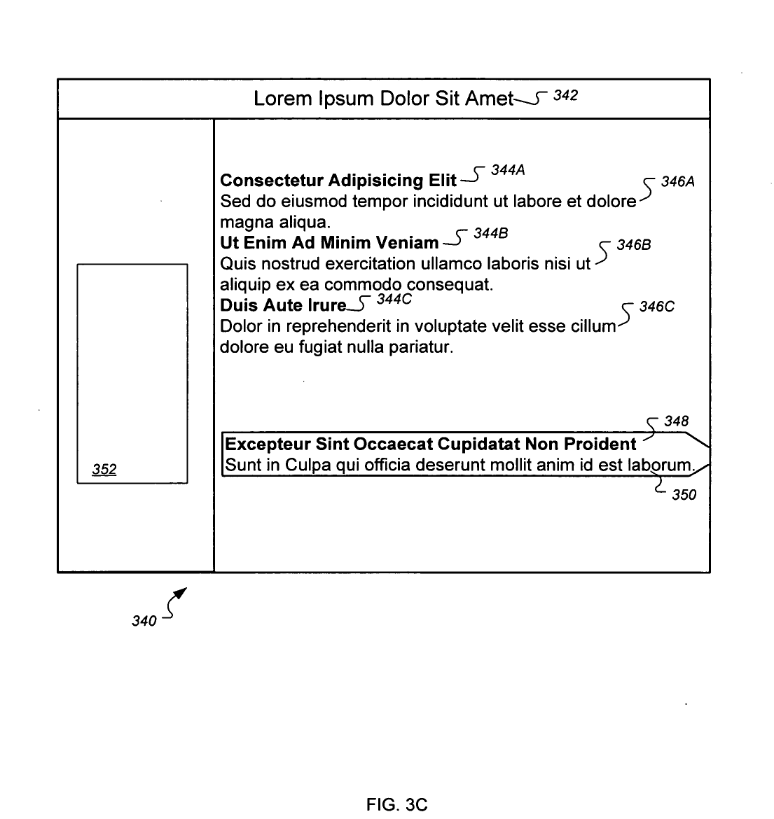

FIGS. 3A-C show an example of creating a UI using metadata. Here, the user wants to view the UI of presentations from software vendors (such as Microsoft Corp.) on the Adobe Acrobat Reader platform. Particularly, the user wants to implement the Adobe UI for the PowerPoint application available from Microsoft. FIG. 3A shows taxonomy metadata 300 that is part of the UI taxonomy for a particular implementation of a PowerPoint slide. The entire metadata for the PowerPoint slide defines the UI in terms of the aspects of its layout, applicable principles and relevant environment. Those aspects that are directly visible in this example will now be described. The metadata 300 defines an image 302 on the left side with a slide header 304 above it. On the right side are three subject lines 306A-C. There is also a concluding statement 308, in the shape of a moving animation: an arrow that slides in from left to right. Each of the subject lines 306 has a text 310 associated with it; the concluding statement 308 has a corresponding text 312. Thus, these aspects of the UI are defined by the metadata 300. All taxonomy metadata will be used in the virtualization.

FIG. 3B shows service metadata 320 representing the UI service that holds the actual UI metadata of our slide. In this case, the metadata holds the texts for the slide at issue and the place for retrieving the image. Here, the metadata 320 includes: text 322 for the slide header 304; texts 324A-C for the subject lines 306A-C, respectively; and a text 328 for the concluding statement 310 and a text 330 for the conclusion text 312. An address 332 in the metadata 320 identifies where to obtain the image. The information in the taxonomy metadata 300 and the service metadata 320 will be used to regenerate the slide to be presentable and viewable on Adobe Reader.

Based on the UI taxonomy metadata and the web services metadata having been defined and gathered, the following procedure may be performed to design the UI. The particular service has been selected and associated with the taxonomy that is to be used. A new UI layout is created in the corresponding taxonomy, having the necessary UI patterns. In this example, a pattern for a slide show presentation may be used; in other implementations, a text edit pattern may be used, for example. The web service may be associated with data types identified using web service definition language (WSDL). These WSDL data types are imported into the UI layout. The UI topology for the layout is modeled using a program such as Visual Composer. The topology may define the slide configuration shown in FIG. 3A, or it can define five navigable screens, to name just two examples.

The following is an example of implementing the UI to use the selected web service. The implementer beings the development project using an IDE of the developer's choice. The developer builds a composite application where one of the integrated services is the selected web service (such as the slide show or an email service). The metadata is received from the UI taxonomy, for example in form of existing UI building blocks. The UI elements and patterns are bound appropriately to the relevant UI contexts and with relevant properties. If any additional front-end logic is to be used, or ad-hoc enhancements are to be made, they may be coded at this point.

During development of the UI according to the above description of FIGS. 3A and 3B, a designer may suggest the Adobe screen elements that are to be used, and these elements are provided for the virtualization. The elements of the PowerPoint UI are then mapped to a generic format defined by the UI taxonomy, and from there to the Adobe elements. The taxonomy may also define a pattern for the UI, and the elements to be used are then associated with that pattern for use in the resulting UI. The UI services that are defined by the services metadata give the developer an understanding of mandatory and optional features of the web service. From this is created an executable that can be deployed in an Adobe runtime.

FIG. 3C shows a UI 340 that is generated by merging UI taxonomy metadata, including the metadata 300, with services metadata, including the metadata 320. The UI 340 includes a header 342 as defined by the respective bodies of metadata. There are subject lines 344A-C with corresponding texts 346A-C. A concluding statement 348 has a corresponding text 350. An image 352 is located as specified by the definition and the concluding statement 348 and its text are enclosed within a sliding arrow.

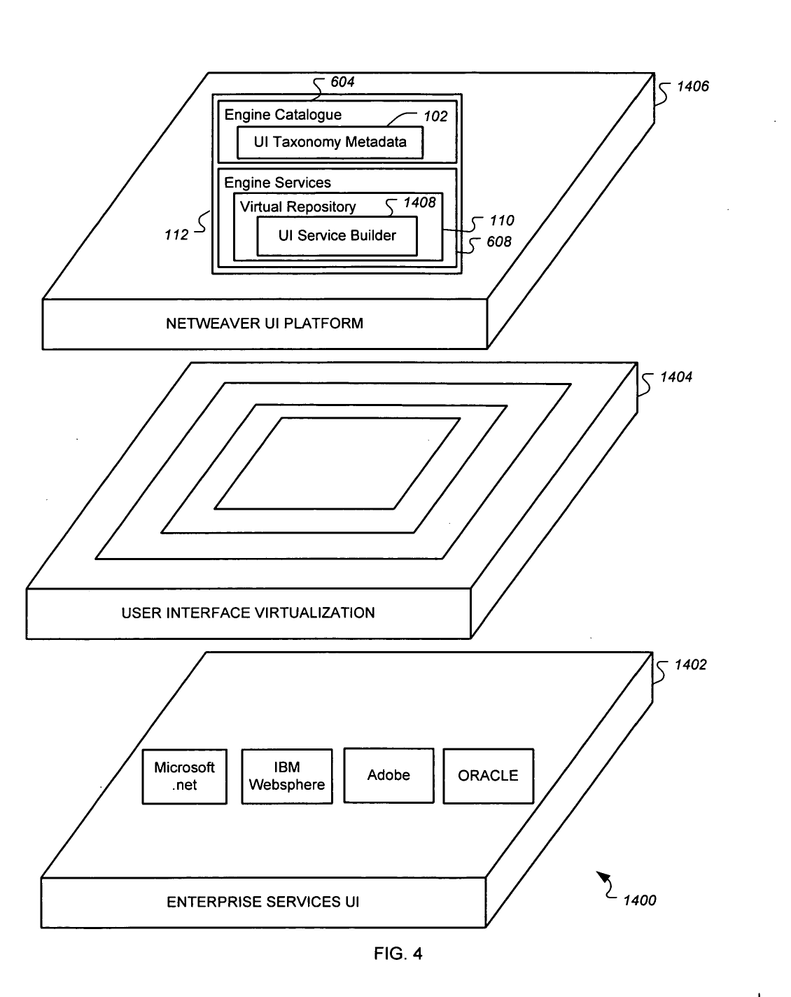

FIG. 4 shows a hierarchy 1400 that can be implemented in a system to provide the above-described and other functions. A bottom of the hierarchy 1400 includes an enterprise services UI layer 1402. This may include components from one or more vendors, for example any or all of the components 204 shown in FIG. 2. These components expose business logic as web services, for example as described above. The hierarchy 1400 includes a virtualization layer 1404 on top of the enterprise services UI layer in which the web services are virtualized. For example, the virtualization layer may group the available web services and merge the relevant bodies of metadata.

The hierarchy includes a UI platform layer 1406 that provides the UI taxonomy metadata, among other functions. Particularly, the UI platform layer here includes a UI engine 112 that can be used in generating and modifying the UI, and in managing other aspects of UI development, maintenance and use. The UI engine includes an engine catalogue 604 and engine services 608. Here, the engine catalogue 604 includes the UI taxonomy metadata 102 while the virtual repository is shown as part of the engine services 608. Thus, the engine catalogue 604 may be a storage place for relevant UI taxonomy metadata and the virtual repository may be a module that actively provides access to it and manages its contents.

Thus, using the virtual repository the UI engine can retrieve and merge the relevant metadata for generating a UI for a composite application. Having done that, the UI virtual repository can call the same composite application and instead run it on a different user platform (such as a smart client, a browser, or a desktop environment). Based on the UI taxonomy, the virtual repository dispatches the call to the appropriate NetWeaver runtime for rendering the composite application. The virtual repository performs the virtualization; that is, it considers and merges the metadata of the UI taxonomy with the metadata of the UI services used in the composite application. This may allow a customer sales person to access a sales order composite application on a Smart Phone, to name one example.

The virtual repository holds the metadata of the UI services so that they can be used in virtualization. When a web service exposes its particular metadata, the metadata can be retrieved therefrom and placed in the virtual repository. This is likely a common situation in the scenario where the web services are provided according to a format that is standardized among many or all market participants. There may, however, exist web services for which the metadata is not so exposed, yet it is desirable to have the ability to include them in the virtualization.

For such situations, the virtual repository may be provided with a UI service builder 1408 that can create the UI metadata for any web services that do not expose it. That is, the virtual repository may first determine that a particular web service does not expose the relevant metadata for virtualization. The UI services builder 1408 can then access the web service, perform tests as necessary and retrieve the relevant information about the specific web service.

For example, using Eclipse or similar tools an independent software vendor or customer can design a UI representation behind a specific web service. This UI metadata can be stored in such a virtual repository.

The following is an example of three development phases that a particular vendor or organization may go though in the implementation and use of a virtual repository. For consistency, that entity is chosen to be SAP AG in the following. During the first phase, SAP may expand the reach of UI taxonomies with non-SAP UI solutions from third-party vendors. The set of UI objects can be delivered as partner-developed UI solutions to serve as templates and best practices when developing non-SAP UI solutions. One example of this is that if a customer or partner has a prevailing technical skill set with a Microsoft IDE and run-time, then the new taxonomy for the Microsoft UI assures that user requirements are applied and that standards are followed when developing applications under the Microsoft platform.

Essentially, SAP can extend to customers and partners the benefits of applying process automation to non-SAP UIs, such as compliance with usability standards. At the same time, SAP would be able to define UI taxonomies of non-SAP solutions and can leverage this as an added flexibility. For example, SAP can analyze UIs and register the layouts, principles, environments and styles that define them. The second phase may be geared toward establishing a common understanding of the look-and-feel of a web service. For example, SAP and other software vendors can agree on the terms of a new standard for defining a web service; in other words, develop a UI service, as the term is used here. This will allow any vendor to build a UI for an SAP or a non-SAP application in any development environment.

The third and last phase in this example also illustrates a possible goal of using the virtual repository: to virtually federate cross-vendor UI scenarios all under one UI run-time platform. Offering access to the third-party UI taxonomies and UI services can provide enough standard-based information about the non-SAP UI scenarios that they can independently be run on a single platform. For SAP, this could mean the ability to run all UIs of SAP and non-SAP applications from an application platform such as NetWeaver that is based on the SAP Enterprise Services Architecture (ESA) or the Service-Oriented Environment (SOE). The result is that SAP and non-SAP UI content can be better assembled, virtually visualized, adapted and searched. Consolidation of application infrastructures to a single platform becomes possible.

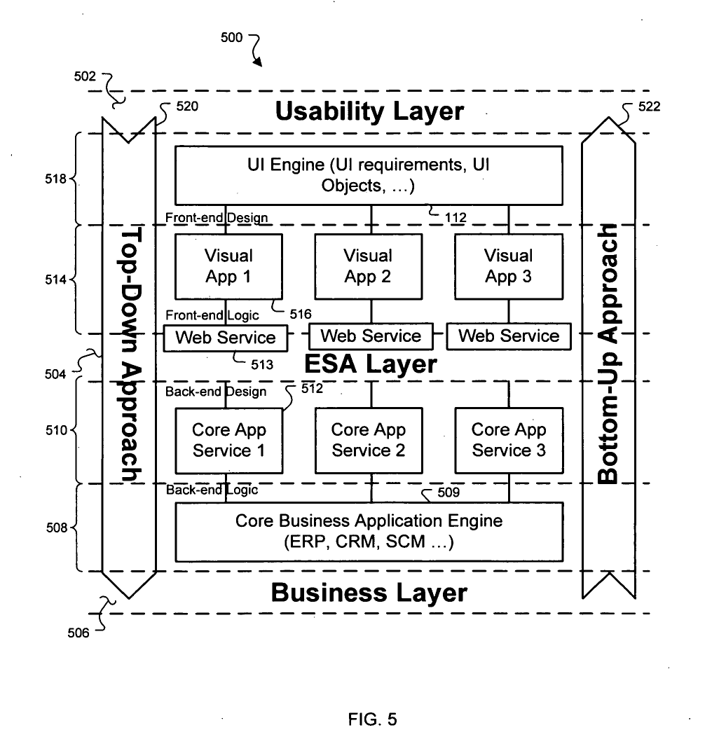

FIG. 5 shows an example of a layer architecture 500 that uses web services. Here, the layer architecture 500 includes a usability layer 502, an ESA layer 504 and a business layer 506. The usability layer 502 relates to anything that the user sees and actively works with in the system. The business layer 506 relates to the underlying models and software that handles the business data and can perform a variety of operations. The ESA layer 504 relates to one or more services that are provided to users through the usability layer 502, the services using one or more of the operations in the business layer 506.

The business layer 506 includes back-end logic 508 that may be represented by common applications addressing business requirements, such as a CRM application or another ERP application. For example, the back-end logic 508 may include a core business application engine 509 providing the application(s). The business layer 506 also includes a back-end design 510 where at least one core application service 512 is modeled; for example, a service for creating a sales order. The ESA layer (or a SOA layer) may in turn make the at least one core application service 512 available as a standard-based, platform-independent web service 513, meaning that it can be accessed from the usability layer using web technology. Here, the ESA layer provides several web services 513.

The usability layer 502 includes front-end logic 514 that is represented by at least one visual application 516 that when appropriate consumes the web service(s) exposed by the ESA layer. The UI engine 112 (see also FIG. 4) is part of a front-end design 518 of the usability layer in which usability requirements are addressed. The UI engine 112 is configured to provide the visual application 516 with the necessary service(s) derived from the usability layer as well as any UI requirements imposed from the business or ESA layer. FIG. 5 may be considered an “outside view” of the exemplary UI engine 112.

The taxonomy 102 (see FIG. 1) is to be provided with metadata that makes it an abstraction of a class of UIs, as has been mentioned. Such metadata can include, among other features, a UI requirement that is to be taken into account when implementing the UI. The UI requirement metadata can be flexibly captured by any of several approaches. For example, the UI requirement may be received through a top-down approach 520 from the usability layer 502 toward the ESA layer 504, or through a bottom-up approach 522 from the ESA layer 504 toward the usability layer 502. In the top-down approach 520, the UI requirement may result from interviewing end-users, creating persona descriptions or delivering role specifications. In the bottom-up approach 522, the UI requirement may originate in a restriction that exists at a technical level. The UI engine 112 allows an infrastructure developer to define requirements of existing and new UI elements, patterns, or at least one web service, to name a few examples.

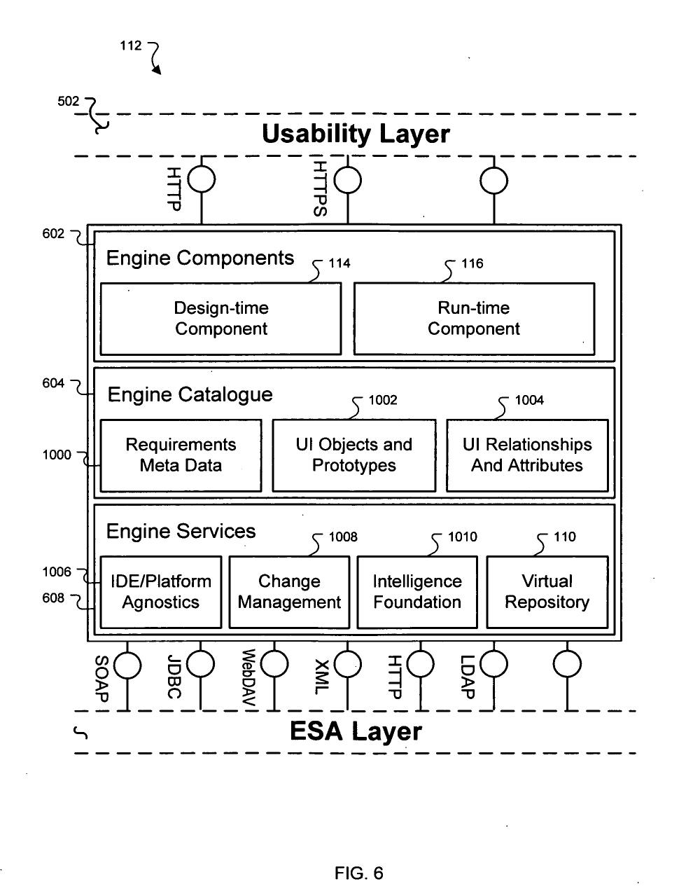

FIG. 6 shows an exemplary architecture for the UI engine 112 made out of three parts: engine components 602, the engine catalogue 604 and the engine services 608 that were described with reference to FIG. 4. The architecture of the UI engine 112 is shown between the usability layer 502 and the ESA layer 504.

Users in the system—such as UI designers, infrastructure developers, application developers and end-users—can interact with any or all of the engine components 602 in a design environment or in a runtime environment, or both. Particularly, they can interact with a design-time component 114 or with a run-time component 116. The design-time component 114 can be used in generating UI objects and for developing UI prototypes, for example. The run-time component 116 can provide information about UI requirements or UI objects.

The engine catalogue 604 here contains a requirements metadata portion 1000 that includes all the metadata derived from the UI requirements. The engine catalogue 604 includes a UI objects and prototypes portion 1002. For example, this portion is for the UI objects and UI prototypes generated with the design-time component 114. In various embodiments, the engine catalogue also includes a UI relationships and attributes portion 1004 that includes relationships and attributes used by either or both of the design-time component 114 and the run-time component 116.

The engine services 608 are generic services used inside or outside the engine. For example, the engine services may be used in communicating UI rules and concepts to a development tool such as Adobe Designer. This allows the UI engine 112 to work with products of other software vendors to support the development of UIs on third-party platforms. The engine services 608 includes an IDE/platform agnostics portion 1006 that allows the engine 112 to interact with different IDEs or with different platforms. For example, the portion 1006 may provide that the engine 112 interacts with different GUI builders, editors and compilers, to name just a few examples. A change management portion 1008 may manage changes in the UI engine 112. For example, the changes may relate to the UI objects or the UI prototypes.

The engine services 608 includes an intelligence foundation 1010 that may be a technical component built to provide adaptive UI personalization, manage end-user performance metrics, and maintain UI history. In some implementations, the intelligence foundation 1010 provides or interacts with a UI agent software providing a context-aware, affinity-enabled UI that anticipates user needs and assists with goals. The engine services 608 may further include the virtual repository 110. As noted above, the virtual repository may comprise a module that provides access to, and manipulation of, metadata to be used in virtualization.

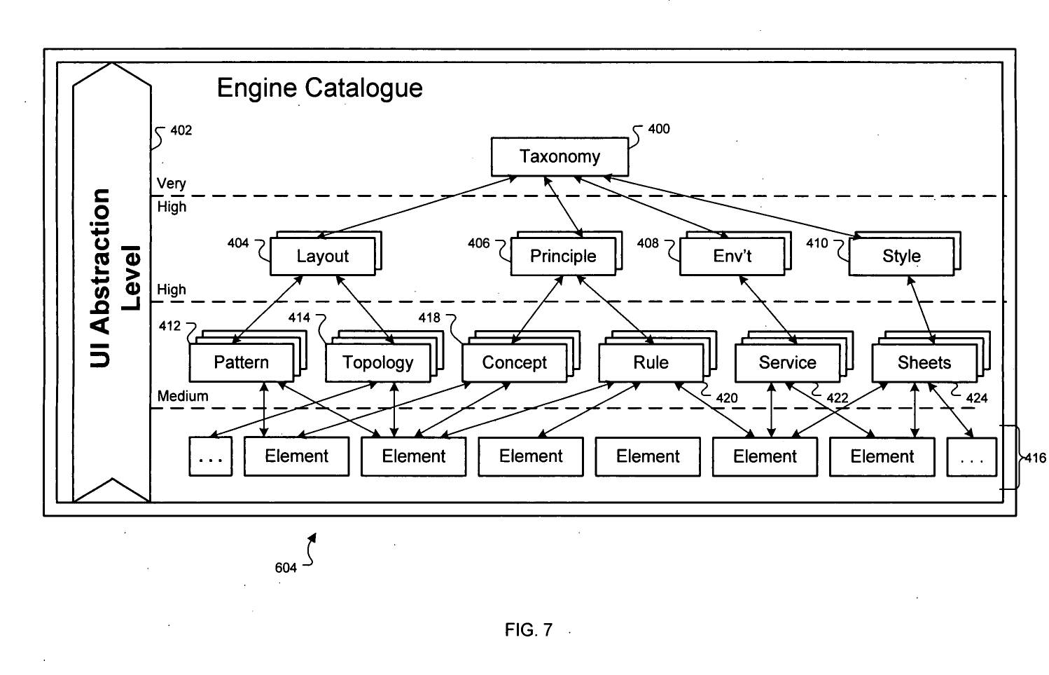

FIG. 7 shows an example of the engine catalogue 604 that can be used in any or all of the system 100, the hierarchy 1400, the UI engine 112 and the architecture 500. The engine catalogue 604 includes a taxonomy 400 that is a classification scheme of information components (for example, terms, concepts, graphics, sounds, etc.) and their interrelationships. For example, the UI taxonomy metadata 110 can be included in the taxonomy 400. The taxonomy 400 is a hierarchical classification of UI objects and their interrelationships that supports the user in identifying the UI of an application and its features. Here, the taxonomy 400 is hierarchically arranged according to an abstraction level 402 that ranges from very high to low. The taxonomy 400 represents a very high abstraction level of UI objects and it groups together possible Layouts, Principles, Environments and Styles allowed in a UI.

The UI taxonomy 400 holds the metadata that is to be used in virtualization. It can also otherwise help UI designers and infrastructure developers in their work by providing a placeholder for the metadata arriving from usability or technical UI requirements and standards. Furthermore, the taxonomy 400 can improve consistency and support innovations by application developers while implementing the UI. The UI taxonomy 400 can also provide on-demand help for end-users who have problems understanding the navigation, content or functions of an application.

At the high level of UI abstraction, the taxonomy 400 includes one or more of: a UI layout 404, a UI principle 406, a UI environment 408 and a UI style 410. The UI layout 404 can include a definition of any layout to be used in a UI, for example that used in the FIG. 3 example above. The UI principle 406 can include the mandatory or recommended guidelines that should apply to the UI. The UI environment 408 can define any environment in which the UI is to be used, such as the Enterprise Portal used in products available from SAP AG. The UI style 410 can define any style to be applied to the UI, for example in terms of its font type and size. Each of the UI layout, the UI principle, the UI environment and the UI style can characterize the UI taxonomy and contribute to a definition of a UI class that can be created with the taxonomy. When at least a UI layout and a UI principle are included, the UI taxonomy is an abstraction of a class of UIs that are consistent with the UI layout and the UI principle.

Each layout 404 can include one or more UI patterns 412 and one or more UI topologies 414. The UI patterns and UI topologies are at a medium level of UI abstraction. A UI pattern is an archetype used to perform a task common to a number of applications. A UI topology represents the layout navigation, capturing the possible event-loop of screens/steps/clicks that can be used. Each UI pattern and UI topology can involve one or more UI elements 416, which are situated at a low level of UI abstraction in the taxonomy 400. The UI elements 416 are a low abstraction level of UI objects that are representative of the basic controls available in a UI.

At the medium abstraction level, the UI principle 406 can have one or more UI concepts 418 and one or more UI rules 420. The UI concepts 418 may include UI guidelines that are recommended but not mandatory. The UI rules 420, in contrast, may include those provisions that must be followed in the UI. Each UI concept and UI rule can apply to one or more of the UI elements 416.

The UI environment 408 can include one or more UI services 422 at the medium level of UI abstraction. The UI service is a platform function that makes up part of the run-time environment where taxonomies can work properly. Each UI service can involve one or more of the UI elements 416.

The UI style 410 can include one or more UI sheets 424 at the medium level of UI abstraction. Sheets are the color/fonts/generic features for the delivered UI. Each UI sheet applies to one or more of the UI elements 416.

The UI taxonomy 400 may be distilled from the standards and requirements of the usability, business and technical layers of enterprise software as an abstract representation of a class of UIs that are consistent therewith. UI taxonomies can create order in the unstructured world of UI design. UI taxonomies can facilitate a decoupling of front-end design from front-end logic and provide transparency and accountability between the tasks of UI designers and developers. UI taxonomies can also provide automated functions to account for and communicate guidelines to all development participants.

More than one UI taxonomy can be referenced in a software application program. In products from SAP AG, separate UI taxonomies may be implemented for Self-Services, Accessibility, Reporting, Mobile, and other applications. Priorities can be applied, for example by weighting the objects of UI taxonomies. For example, the UI taxonomy for Accessibility may be given the highest priority in any standard enterprise application, and its UI rules and concepts may then take precedence over others.

The UI patterns, services and elements are sometimes considered a UI vocabulary in the system. As such, they may map to corresponding, platform-specific objects. One example is to map one of the UI patterns to the Microsoft Archetype and to the SAP Web Dynpro Pattern. Another example is mapping one of the UI services to the IBM WebSphere Service and to the SAP J2EE Service. Yet another example is to map one of the UI elements to the Adobe Designer Object and to SAP NetWeaver Control. This would indicate, for example, that an Adobe Table Object is the same as an SAP NetWeaver Table Control and they all map to the same table-oriented UI element. This way, UI taxonomies can be generated for third-party UIs that account for their platform-specific needs and requirements.

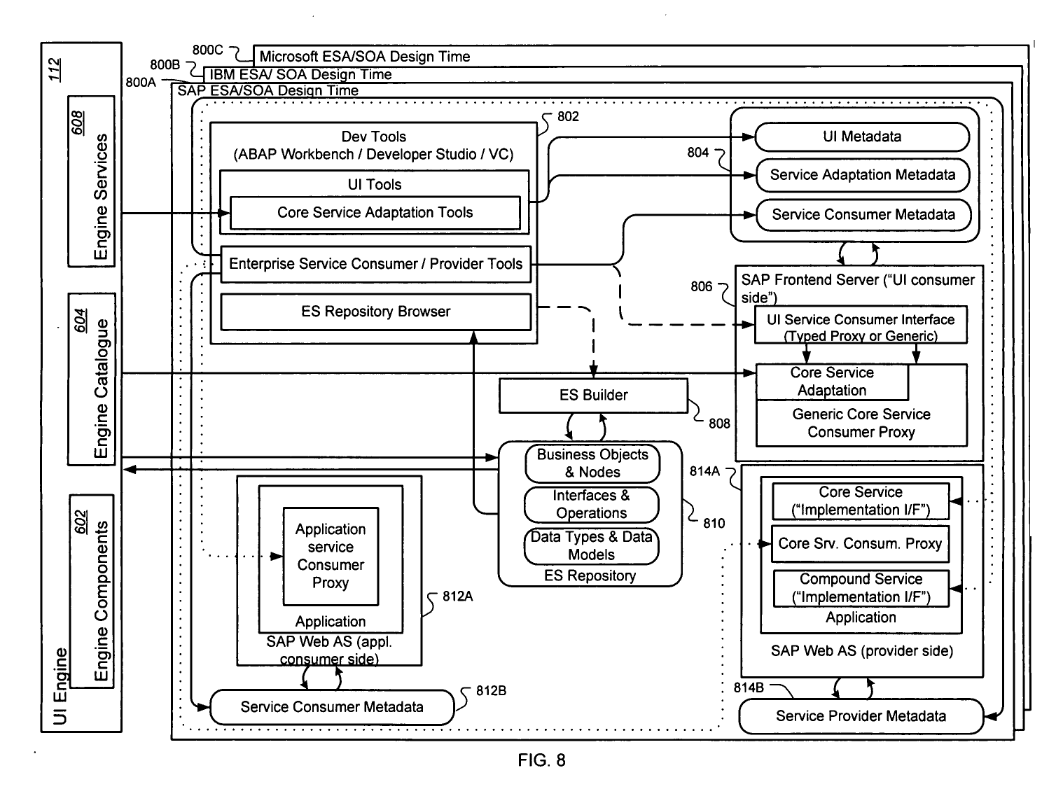

FIG. 8 shows an example of design time interaction between a repository of metadata and an enterprise services infrastructure. Particularly, the UI engine 112 is shown as being capable of interacting with any or all of several design times 800. A first design time is the SAP ESA/SOA design time 800A. The design time 800A includes development tools 802 that may be included in the ABAP Workbench, Developer Studio or Visual Composer. This includes UI tools among other types of tools. The development tools are associated with a metadata unit 804 that includes UI Metadata, Service Adaptation Metadata and Service Consumer Metadata. Thus, the storage 804 manages the UI metadata that can be used in virtualization. As such, the storage 804 interacts with an SAP Frontend Server 806 that includes a UI Service Consumer Interface that interacts with a Generic Core Service Consumer Proxy through a Core Service Adaptation. The UI engine 112 interacts with the development tools 802 and through them indirectly with the unit 804.

The SAP design time 800A also includes an Enterprise Services (ES) Builder that interacts with an ES Repository 810. The repository includes business objects, interfaces, data types and data models, to name a few examples. The UI engine 112 interacts with the ES repository.

The SAP design time 800A also includes a first SAP Web Application Server 812A which corresponds to the application consumer side. The Server 812A includes an Application and an Application Service Consumer Proxy which is generated using the development tools 802, and can interact with a Service Consumer Metadata 812B.

The SAP design time 800A also includes a second SAP Web Application Server 814A which corresponds to the application provider side. The Server 814A includes an Application, and also a Core Service, a Core Service Consumer Proxy and a Compound Service that are all generated using the development tools 802. The Server 814A can interact with a Service Provider Metadata 814B.

The above outlines some functions within the SAP design time 800A and the interactions that the UI engine 112, including any of its components 602, catalogue 604 and services 608 can have therewith. Similar interactions may take place between the UI engine 112 and a second design time 800B associated with IBM Corp. or a third design time 800C associated with Microsoft Corp. For example, each of the design times 800B and C may have components corresponding to those described above and that perform similar functions.

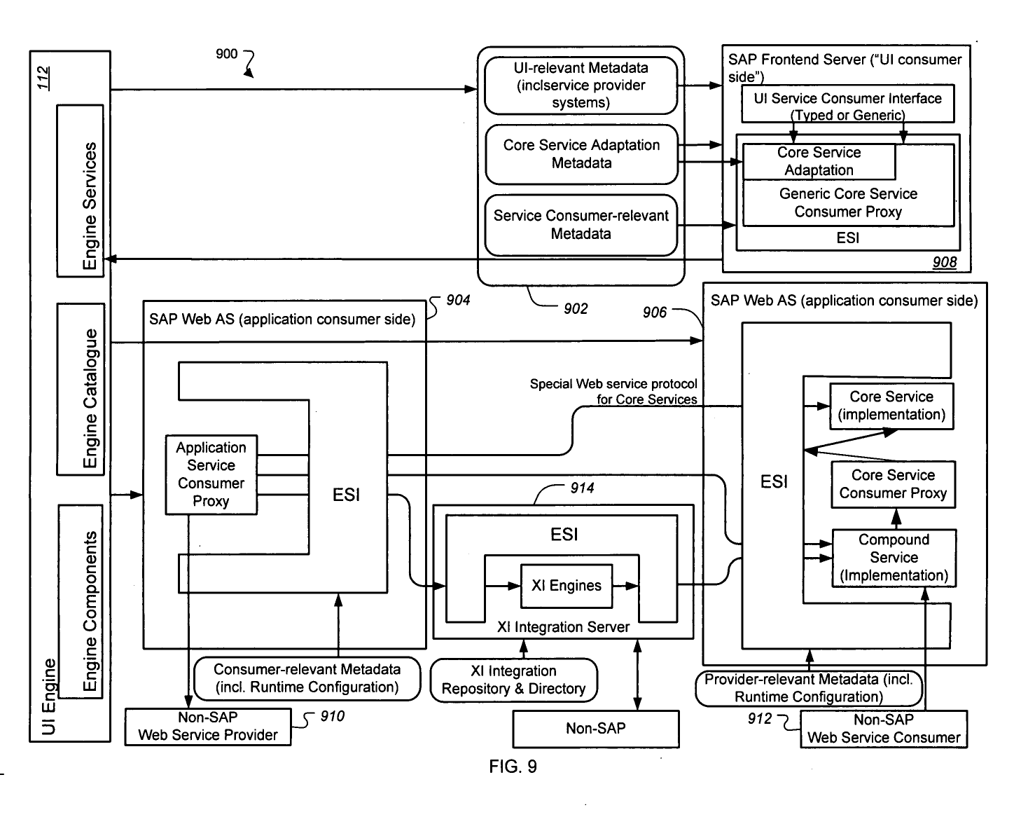

FIG. 9 shows an example of interaction at runtime between a repository of metadata and an enterprise services infrastructure. Here, the UI engine 112 interacts with a runtime 900 that is the SAP ESA/SOA Runtime. Particularly, the UI engine interacts with a metadata unit 902, a first SAP Web Application Server 904 for the application consumer side, and a second SAP Web Application Server 906 for the application provider side. The consumer-side Server 904 and the provider-side Server 906 can interact directly with each other or through an SAP Exchange Infrastructure (XI) Integration Server 914. The consumer-side Server 904 can also interact with a Non-SAP Web Service Provider 910, and the provider-side Server 906 can also interact with a Non-SAP Web Service Consumer 912. The metadata unit 902 interacts with an SAP Frontend Server 908 which also can interact with the UI engine 112.

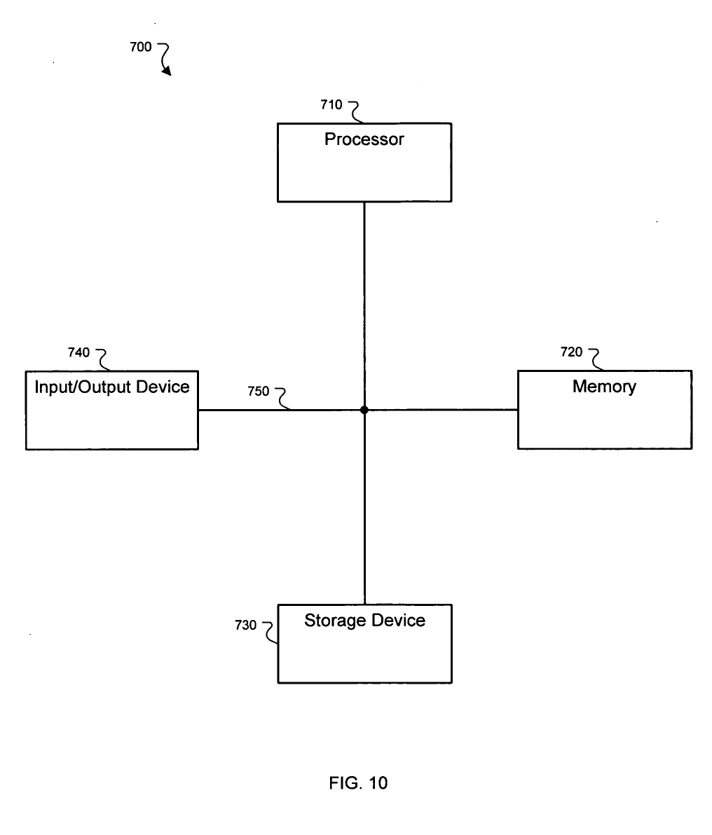

FIG. 10 is a block diagram of a computer system 700 that can be used in the operations described above, for example in the system 100. The system 700 includes a processor 710, a memory 720, a storage device 730 and an input/output device 740. Each of the components 710, 720, 730 and 740 are interconnected using a system bus 750. The processor 710 is capable of processing instructions for execution within the system 700. In one embodiment, the processor 710 is a single-threaded processor. In another embodiment, the processor 710 is a multi-threaded processor. The processor 710 is capable of processing instructions stored in the memory 720 or on the storage device 730 to display graphical information for a user interface on the input/output device 740.

The memory 720 stores information within the system 700. In one embodiment, the memory 720 is a computer-readable medium. In one embodiment, the memory 720 is a volatile memory unit. In another embodiment, the memory 720 is a non-volatile memory unit.

The storage device 730 is capable of providing mass storage for the system 700. In one embodiment, the storage device 730 is a computer-readable medium. In various different embodiments, the storage device 730 may be a floppy disk device, a hard disk device, an optical disk device, or a tape device.

The input/output device 740 provides input/output operations for the system 700. In one embodiment, the input/output device 740 includes a keyboard and/or pointing device. In one embodiment, the input/output device 740 includes a display unit for displaying graphical user interfaces. For example, the input/output device can generate any or all GUIs described herein.

The invention can be implemented in digital electronic circuitry, or in computer hardware, firmware, software, or in combinations of them. Apparatus of the invention can be implemented in a computer program product tangibly embodied in an information carrier, e.g., in a machine-readable storage device or in a propagated signal, for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the invention can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The invention can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. Accordingly, other embodiments are within the scope of the following claims.

What is claimed is:

1. A method of creating a user interface, the method comprising:
receiving a request to create a user interface (UI) for an application that is to use a service;
retrieving first metadata from a UI taxonomy that is an abstraction of a class of UIs, the first metadata providing that the created UI is a member of the class;
retrieving second metadata that defines the service; and
creating the UI by merging the first and second metadata.

2. The method of claim 1, wherein the service is comprised of a web service and a UI service.

3. The method of claim 2, wherein the UI service defines a look-and-feel aspect of the web service.

4. The method of claim 1, wherein the UI taxonomy is configured such that the class of UIs is consistent with a UI layout and a UI principle included in the UI taxonomy.

5. The method of claim 4, wherein at least one UI pattern and a UI topology are included in the UI layout.

6. The method of claim 4, wherein the UI taxonomy is further configured such that the class of UIs is consistent also with a UI environment included in the UI taxonomy.

7. The method of claim 1, wherein the service does not expose the second metadata, further comprising creating the second metadata using the service, wherein the second metadata can be retrieved upon creation.

8. The method of claim 1, wherein the UI is created to make the application a composite application for running on a first platform, wherein the UI taxonomy maps to UI objects for the first platform.

9. The method of claim 8, further comprising generating, in response to receiving a user input, another UI for use in running the application on a second platform.

10. The method of claim 9, wherein the other UI is generated by retrieving other metadata from another UI taxonomy that maps to UI objects for the second platform, and merging that other metadata with the second metadata that defines the service.

11. A computer program product tangibly embodied in an information carrier, the computer program product including instructions that, when executed, cause a processor to perform operations comprising:
receiving a request to create a user interface (UI) for an application that is to use a service;
retrieving first metadata from a UI taxonomy that is an abstraction of a class of UIs, the first metadata providing that the created UI is a member of the class;
retrieving second metadata that defines the service; and
creating the UI by merging the first and second metadata.

12. A computer system comprising:
executable instructions that constitute a service configured for use by an application in the computer system;
a user interface (UI) taxonomy that is an abstraction of a class of UIs; and
a UI generation module configured to retrieve first metadata from the UI taxonomy and second metadata that defines the service, wherein the UI generation module generates a UI for the application by merging the first and second metadata.

13. The computer system of claim 12, further comprising (1) an enterprise services UI layer, a UI platform layer and a virtualization layer, wherein the UI generation module retrieves the first and second metadata from the UI platform layer.

14. The computer system of claim 12, wherein the service is comprised of a web service and a UI service.

15. The computer system of claim 14, wherein the UI service defines a look-and-feel aspect of the web service.

16. The computer system of claim 14, wherein the web service is provided from a backend layer, and wherein the computer system further comprises an intermediate platform that implements the UI service for use by the application in a composite applications layer.

17. The computer system of claim 16, wherein several web services are provided from the backend layer, and wherein the intermediate platform includes an integration platform that implements the UI service for the several web services.

18. The computer system of claim 12, further comprising a UI services creation component that, when the service does not expose the second metadata, creates the second metadata using the service, wherein the second metadata can be retrieved upon creation.

19. The computer system of claim 12, wherein the UI taxonomy is configured such that the class of UIs is consistent with a UI layout and a UI principle included in the UI taxonomy.

20. The computer system of claim 19, wherein the UI taxonomy is further configured such that the class of UIs is consistent also with a UI environment included in the UI taxonomy.
